(19) United States
(12) Patent Application Publication
(10) Pub. No.: US 2005/0215266 A1
(43) Pub. Date: Sep. 29, 2005

(54) Wireless network dynamic frequency selection

(75) Inventors: Chih C. Tsien, San Diego, CA (US); Jiewen Liu, San Diego, CA (US)

Correspondence Address: LeMoine Patent Services, PLLC;c/o PortfolioIP, P.O. Box 52050, Minneapolis, MN, 55402, US

(73) Assignee: Intel Corporation

(21) Appl. No.: 10/810,532

(22) Filed: Mar. 26, 2004

(51) Int. Cl. H04Q 7/20

(52) U.S. Cl. 455/454; 455/67.11

(57) ABSTRACT

A central controller provides centralized dynamic frequency selection in a wireless network.

### FIELD

The present invention relates generally to computer networks, and more specifically to wireless networks.

### BACKGROUND

Wireless networks typically utilize one or more “channels” in a frequency spectrum. Some of the channels may also be used by other types of systems, such as radar systems. When channels are shared between wireless networks and other systems, interference may result.

### BRIEF DESCRIPTION OF THE DRAWINGS

FIG. 1 shows a diagram of a central controller coupled to a wireless network;

FIG. 2 shows a diagram of a central controller coupled to a wireless network through a wired network;

FIG. 3 shows a diagram of a central controller; and

FIG. 4 shows a flowchart in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

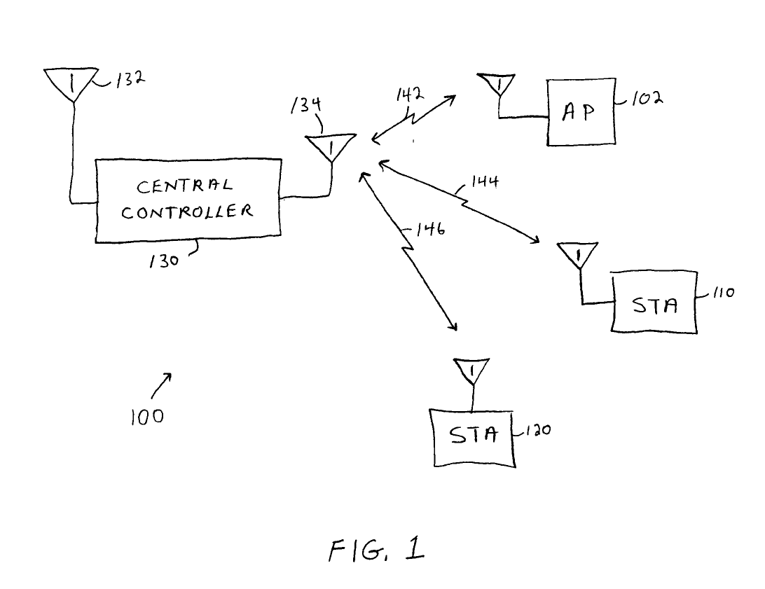

FIG. 1 shows a diagram of a central controller coupled to a wireless network. Wireless network 100 includes access point (AP) 102 and mobile stations (STA) 110 and 120. In some embodiments, wireless network 100 is a wireless local area network (WLAN). For example, one or more of mobile stations 110 and 120, or access point 102 may operate in compliance with a wireless network standard such as ANSI/IEEE Std. 802.11, 1999 Edition, although this is not a limitation of the present invention. As used herein, the term “802.11” refers to any past, present, or future IEEE 802.11 standard, or extension thereto, including, but not limited to, the 1999 edition. Mobile stations 110 and 120 may be any type of mobile station capable of communicating in network 100. For example, the mobile stations may be computers, personal digital assistants, wireless-capable cellular phones, home audio or video appliances, or the like.

In some embodiments, AP 102 communicates with STAs 110 and 120 in a basic service set (BSS). This may also be referred to as “infrastructure mode.” In other embodiments, STAs 110 and 120 may communicate with each other directly in an independent basic service set (IBSS). This may also be referred to as “ad-hoc mode.” Various embodiments of the present invention may be described herein with reference to either or both of infrastructure and ad-hoc modes, but this is not a limitation of the present invention. For example, embodiments described with reference to infrastructure mode may also be used in ad-hoc mode, and embodiments described with reference to ad-hoc mode may be used in infrastructure mode.

Central controller 130 monitors a frequency spectrum using antenna 132 and determines if any radar signals are present that might interfere with operation of wireless network 100. For example, central controller 130 may monitor frequencies in the five gigahertz (5 GHz) band to determine if any radar signals are present. In some embodiments, central controller 130 scans radar bands such as 5.25 GHz to 5.725 GHz, and records channel information and signal characteristics of any detected radar signals. In some embodiments, central controller 130 may also monitor the radar bands for any wireless network signals. In general, central controller 130 may monitor any frequency band of interest, and may record information regarding any signals found.

In embodiments represented by FIG. 1, central controller 130 includes a network interface coupled to antenna 134. The network interface is a wireless network interface capable of communicating in wireless network 100. For example, the network interface may be an 802.11 compliant network interface. In some embodiments, central controller 130 may associate with wireless network 100. For example, in ad-hoc mode, central controller 130 may associate with one or both of STAs 110 and 120. Also for example, in infrastructure mode, central controller 130 may associate with AP 102.

Central controller 130 may utilize the network interface and antenna 134 to communicate information regarding the frequency band of interest to other transmitters in wireless network 100. For example, central controller 130 may communicate with AP 102, STA 110, and STA 120 using signals 142, 144, and 146, respectively. As part of the information transmitted, central controller 130 may transmit dynamic frequency selection information to the various transmitters in wireless network 100. As used herein, “dynamic frequency selection information” refers to any information regarding the frequency band of interest. For example, dynamic frequency selection information may include information describing potentially interfering signals found in the frequency band of interest, or dynamic frequency selection information may include information describing channels where no potentially interfering signals are found. In some embodiments, dynamic frequency selection information includes one or more channel assignments that assign channels for use by the remainder of wireless network 100.

In some embodiments, central controller 130 transmits signals 142, 144, and 146 in a channel that is known to be free from interfering signals, such as radar signals. For example, central controller 130 may communicate with other transmitters in wireless network 100 using a channel between substantially 5.15 GHz and 5.25 GHz, which in some embodiments, is typically free from radar signals. In these embodiments, access points and mobile stations may periodically visit the channel to get the latest channel assignment information. In other embodiments, central controller 130 may communicate with other transmitters in wireless network 100 using channels known by central controller 130 to be currently free from interfering signals. For example, central controller 130 may transmit signals 142, 144, and 146 in a channel between 5.25 GHz and 5.725 GHz known to central controller 130 to currently be free from other signals.

Central controller 130 is referred to as a “central controller” in part because it centralizes the functions corresponding to detection of interfering signals and providing dynamic frequency selection information. This is in contrast to a distributed system in which multiple access points and/or mobile stations include circuits for detection and avoidance of potentially interfering signals. Central control of radar detection and dynamic frequency selection allows access points and mobile stations to be designed without these functions, and without the associated costs.

The operation of central controller 130 in the context of wireless network 100 has been described with reference to the 5 GHz band, but this is not a limitation of the present invention. For example, central controller 130 may be used in any wireless band subject to potentially interfering signals. Various embodiments of central controllers are described in more detail below with reference to the remaining figures.

Wireless network 100 is shown with one access point and two mobile stations, but this is not a limitation of the present invention. For example, any number of access points and mobile stations may be in wireless network 100. Further, central controller 130 may provide dynamic frequency selection information to any number of access points and mobile stations.

Either of antennas 132 and 134 may be a directional antenna or an omni-directional antenna. As used herein, the term omni-directional antenna refers to any antenna having a substantially uniform pattern in at least one plane. For example, in some embodiments, antenna 132 may be an omni-directional antenna such as a dipole antenna, or a quarter wave antenna. Also for example, in some embodiments, antenna 134 may be a directional antenna such as a parabolic dish antenna or a Yagi antenna. In still further embodiments, antenna 132 includes multiple physical antennas and antenna 134 includes multiple physical antennas.

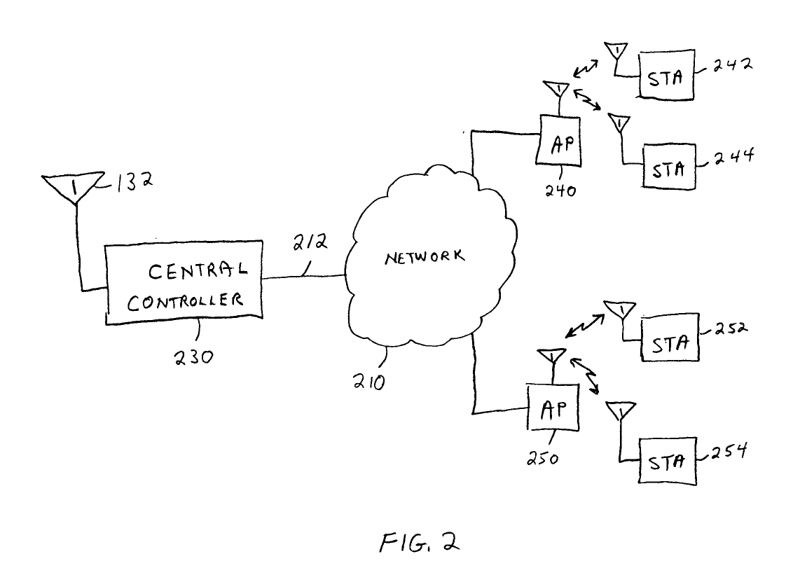

FIG. 2 shows a diagram of a central controller coupled to a wireless network through a wired network. Network 210 may be any type of network, including a local area network (LAN), a wide area network (WAN), the Internet, or the like.

Central controller 230 includes a network interface that is “wired” to network 210 by conductor 212, which is in turn coupled to access points (APs) 240 and 250. The term “wired” refers to any type of coupling other than “wireless.” For example, conductor 212 may be category 5 (CAT 5) cable, and central controller 230 may be coupled to network 210 through an Ethernet interface. In some embodiments, central controller 230 communicates dynamic frequency selection information to access points 240 and 250 through network 210.

Access point 240 is shown communicating with mobile stations 242 and 244 in a first BSS, and access point 250 is shown communicating with mobile stations 252 and 254 in a second BSS. In some embodiments, access points 240 and 250 receive dynamic frequency selection information from central controller 230 as transmitted through network 210. Access points 240 and 250 may communicate the dynamic frequency selection information to all mobile stations in their respective BSSs to coordinate communications in radar-free channels.

FIG. 2 is shown with one central controller coupled to two BSSs through a single network, but this is not a limitation of the present invention. For example, more than two BSSs may be served by a single central controller. Also for example, multiple central controllers may serve any number of BSSs in common. Further, in some embodiments, a single central controller may serve multiple BSSs combined into an extended service set (ESS).

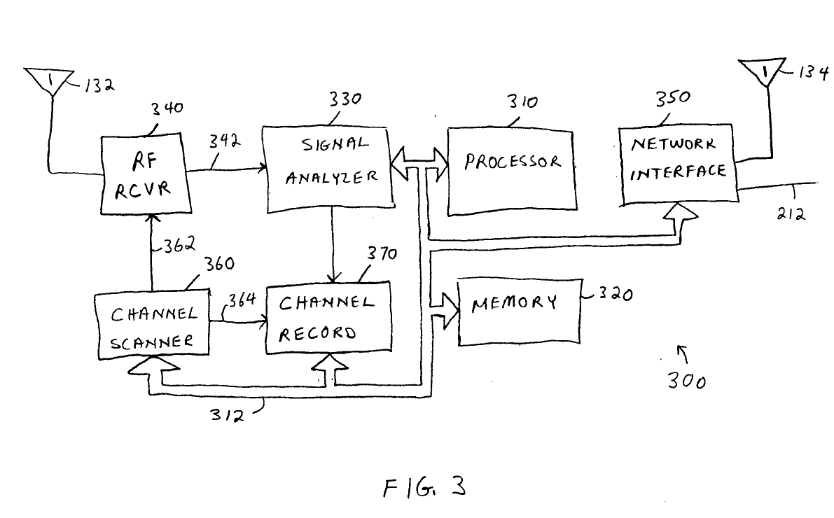

FIG. 3 shows a diagram of a central controller. Central controller 300 includes radio frequency receiver (RF RCVR) 340, signal analyzer 330, channel scanner 360, and channel record 370. Central controller 300 also includes processor 310, memory 320, and network interface 350. Also shown in FIG. 3 are antennas 132 and 134, and conductor 212. Central controller 300 may be utilized as a central controller coupled to a wireless network, such as central controller 130 (FIG. 1) or central controller 230 (FIG. 2).

In operation, central controller 300 scans a frequency band of interest and records information regarding signals detected in the band. The detected signals may be of any type, including for example, radar signals, wireless local area network signals, and the like. For example, in some embodiments, central controller 300 may scan radar bands between substantially 5.25 GHz and 5.725 GHz and record occupied radar channels, radar signal characteristics, occupied wireless LAN channels and other signals found in the 5 GHz bands. After information analysis and processing, central controller 300 may transmit dynamic frequency selection information to wireless devices using network interface 350.

Channel scanner 360, channel record 370, memory 320, and network interface 350 are coupled to processor 310 via bus 312. Bus 312 maybe any type of bus capable of supporting communications between the various elements shown in FIG. 3. For example, bus 312 may include a data bus, address bus, and control signals. Further, central controller 300 may include a memory management unit (not shown) coupled to bus 312. In some embodiments, bus 312 includes a special purpose bus, such as a serial bus, or a bus useful to couple test equipment together.

In some embodiments, processor 310 may be any suitable processor to influence the operation of other circuits such as network interface 350 or channel scanner 360. For example, processor 310 may control which frequency bands are scanned, and may combine information from signal analyzer 330 and channel record 370. Processor 310 may also make decisions regarding signals that are detected. For example, processor 310 may distinguish between wireless network signals and radar pulses. Processor 310 may also determine channels occupied by radar, and determine channel(s) to which a wireless network should move, to meet uniform spreading requirements and avoid adjacent channel interference.

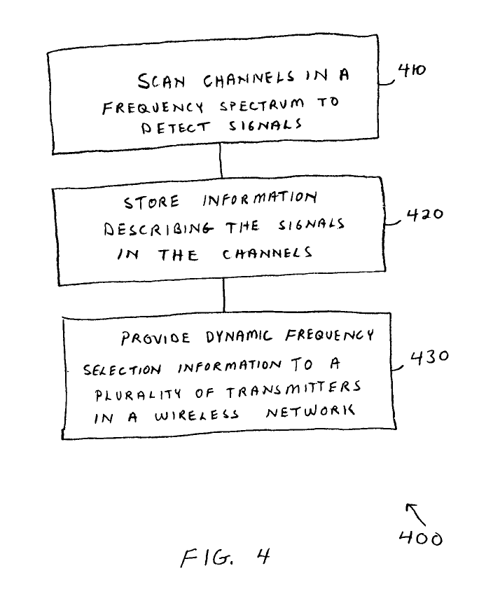

In some embodiments, processor 310 may perform operations in support of method embodiments of the present invention. For example, processor 310 may perform actions in support of those listed in method 400 (FIG. 4), described below. Processor 310 represents any type of processor, including but not limited to, a microprocessor, a digital signal processor, a microcontroller, personal computer, workstation, or the like. Further, processor 310 may be formed of dedicated hardware, such as state machines or the like.

In some embodiments, channel scanner 360 includes a wide band synthesizer with a fast switching time to provide a local oscillator signal to RF receiver 340 on node 362. Channel scanner 360 may also provide channel information to channel record 370 on node 364. In some embodiments, processor 310 may command channel scanner 360 to synthesize an oscillator signal corresponding to a particular channel, and in other embodiments, processor 310 may command channel scanner 360 to sweep through a range of channels using a particular interval. Channel information may be provided to channel record 370 by processor 310 or by channel scanner 364. For example, processor 310 may provide channel information to channel record 370 when commanding channel scanner 360 to tune to a particular channel. Also for example, channel scanner 360 may provide channel information to channel record 370 on node 364 when changing channels.

Receiver 340 receives RF signals from antenna 132 and receives a local oscillator signal from channel scanner 360 on node 362, and in various embodiments, performs varying amounts and types of signal processing. For example, in some embodiments, RF receiver 340 may include amplifiers, mixers, filters, demodulators, analog-to-digital converters, or the like. Also for example, RF receiver 340 may provide an intermediate frequency (IF) signal or a baseband signal to signal analyzer 330 on node 342. In some embodiments, node 342 includes both in-phase (I) and quadrature (Q) signals, in either an analog or digital format. In other embodiments, node 342 includes a single signal with both real and imaginary components combined.

In some embodiments, receiver 340 receives signals that include wireless LAN orthogonal frequency division multiplexing (OFDM) signals, radar signals including narrow pulse radar, chirped radar, synthetic aperture radar (SAR), frequency hopping radar; and other noise and interfering signals. Receiver 340 may include a wideband front end with fast response times to adapt to wideband radar signals such as those with bandwidths of 120 MHz to 300 MHz.

Signal analyzer 330 receives signals from RF receiver 340 on node 342 and provides signal analysis. In some embodiments, signal analyzer 330 analyzes all signals found, and in other embodiments, signal analyzer 330 attempt to detect and analyze specific types of signals. For example, signal analyzer 330 may attempt to detect all wireless LAN signals in a frequency band of interest, as well any signals that may interfere with wireless LAN signals in the frequency band of interest. Signal analyzer 330 may include circuitry to detect radar signals and their characteristics, including radar pulse duration, radar pulse repetition frequency (PRF), radar signal strength, and radar signal bandwidth estimation. Signal analyzer 330 may also perform other suitable signal processing tasks.

Channel record 370 may include memory capable of functioning as a database to store channel information and signal information. For example, as channel scanner 360 sweeps through channels in the frequency band of interest, and signal analyzer 330 detects and measures signals in the channels, channel record 370 may store information regarding the detected signals and the channels in which they are found. The specific type or amount of information stored in channel record 370 is not a limitation of the present invention. For example, channel record 370 may store limited information such as frequency values that mark channels in use, or channel record 370 may store detailed information describing every detected signal in every channel.

Network interface 350 is a network interface capable of providing communications between central controller 300 and network devices external to central controller 300. For example, network interface 350 may include a wireless network interface to communicate with a wireless network such as that shown in FIG. 1. Also for example, network interface 350 may include a wired network interface capable of communicating with a wired network, such as that shown in FIG. 2. In some embodiments, network interface 350 may include both wireless and wired network interfaces, and in other embodiments, network interface 350 may include only a wireless interface or only a wired interface.

In some embodiments, network interface 350 includes a wireless network physical (PHY) layer implementation that is compliant with one or more wireless network standards. For example, network interface 350 may include a PHY that complies with an IEEE 802.11 standard or other standard. Network interface 350 may transmit signals in many different formats, including, but not limited to, direct sequence spread spectrum (DSSS), frequency hopping spread spectrum (FHSS), and orthogonal frequency division multiplexing (OFDM).

In some embodiments, central controller 300 is part of an electronic system that includes a wireless network interface and antenna 134 to broadcast dynamic frequency selection information to wireless LAN devices. Broadcasts may occur in radar-free channels, which in some embodiments, may be between 5.15 GHz and 5.25 GHz.

Memory 320 represents an article that includes a machine readable medium. For example, memory 320 represents any one or more of the following: a hard disk, a floppy disk, random access memory (RAM), dynamic random access memory (DRAM), static random access memory (SRAM), read only memory (ROM), flash memory, CDROM, or any other type of article that includes a medium readable by a machine such as processor 310. In some embodiments, memory 320 can store instructions for performing the execution of the various method embodiments of the present invention.

In operation of some embodiments, processor 310 reads instructions and data from memory 320 and performs actions in response thereto. For example, various method embodiments of the present invention may be performed by processor 310 while reading instructions from memory 320.

In some embodiments, channel record 370 and memory 320 are combined. For example, one memory unit may be utilized to store information describing detected signals, and also instructions and data useful for execution of software in processor 310.

FIG. 4 shows a flowchart in accordance with various embodiments of the present invention. In some embodiments, method 400 may be used to detect signals in a frequency spectrum and provide dynamic frequency selection information. In some embodiments, method 400, or portions thereof, is performed by a central controller, a processor, or an electronic system, embodiments of which are shown in the various figures. Method 400 is not limited by the particular type of apparatus, software element, or system performing the method. The various actions in method 400 may be performed in the order presented, or may be performed in a different order. Further, in some embodiments, some actions listed in FIG. 4 are omitted from method 400.

Method 400 is shown beginning at block 410 in which channels in a frequency spectrum are scanned to detect signals. In some embodiments, this may correspond to channel scanner 360 (FIG. 3) providing a sweeping local oscillator signal to receiver 340 and receiver 340 scanning a frequency band of interest. Channel scanning may be influenced by a processor such as processor 310. A processor may control or influence the operation of a channel scanner by determining which channels to scan and when, or by commanding a channel scanner to perform a sweep.

Any frequency band of interest may be scanned at 410. For example, in some embodiments, radar frequencies that overlap with wireless network bands may be scanned. This may include frequencies above 5 GHz and/or below 6 GHz. In some embodiments, channels between 5.25 GHz and 5.725 GHz are scanned at 410.

Any type of signal may be detected by the actions of 410. For example, detected signals may include wireless LAN signals, radar signals, or any other signals present in the channels that are scanned. The detection process may include measuring characteristics of signals, such as bandwidth, signal strength, pulse width, repetition rate, and the like. Further, detection may include determining what type of signal has been detected. Radar signals may be identified as radar signals, and wireless LAN signals may identified as wireless LAN signals.

At 420, information describing the signals in the channels is stored. This may correspond to a channel record being written, such as channel record 370. Any relevant information may be stored at 420. For example, if detected signals have been identified, the identity of signals may be stored along with information describing the bandwidth occupied by the signals. If the identified signals are not wireless LAN signals, and may interfere with wireless LAN signals, they may be identified as such, and relevant information may be stored.

At 430, dynamic frequency selection information is provided to a plurality of transmitters in a wireless network. The dynamic frequency selection information may include any information pertinent to reducing interference in the frequency band of interest. For example, a central controller may provide information to a wireless network regarding interference-free channels to which the wireless network should move. The dynamic frequency selection information may be provided in many different ways including, through a wireless network or through a wired network. In some embodiments, dynamic frequency selection is transmitted into a wireless network using a channel that is known to be free from interfering signals. For example, dynamic frequency selection information may be transmitted into a wireless network using channels between 5.15 GHz and 5.25 GHz, which is typically free from radar signals that may interfere with wireless networks.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

1. An apparatus comprising:
a receiver to detect radar signals in spectrum used by wireless network signals; and
a network interface to communicate dynamic frequency selection information to at least one transmitter in a wireless network.

2. The apparatus of claim 1 wherein the network interface is configured to provide information regarding spectrum used by the radar signals.

3. The apparatus of claim 1 wherein the network interface is configured to provide information regarding spectrum not used by the radar signals.

4. The apparatus of claim 1 wherein the network interface comprises a wireless network interface.

5. The apparatus of claim 4 wherein the wireless network interface comprises an 802.11 compliant physical layer.

6. The apparatus of claim 5 wherein the wireless network interface transmits in a radar-free channel.

7. The apparatus of claim 5 wherein the 802.11 compliant physical layer is capable of transmitting at frequencies of between 5.15 GHz and 5.25 GHz.

8. The apparatus of claim 5 wherein the wireless network interface is configured to associate with an access point or a mobile station.

9. The apparatus of claim 8 wherein the dynamic frequency selection information comprises a spectral location of radar signals.

10. The apparatus of claim 8 wherein the dynamic frequency selection information comprises a channel open for wireless local area network use.

11. The apparatus of claim 1 wherein the receiver comprises:
a radio frequency front end;
a radar signal analyzer; and
a memory device to record channel records.

12. The apparatus of claim 11 wherein the radio frequency front end includes circuits to scan in one or more bands between substantially 5 GHz and 6 GHz.

13. The apparatus of claim 11 wherein the radio frequency front end includes circuits to scan between substantially 5.25 GHz and 5.725 GHz.

14. The apparatus of claim 1 wherein the network interface includes circuits to transmit wireless local area network signals below substantially 5.25 GHz.

15. A method comprising:
scanning channels in a frequency spectrum to detect signals;
storing information describing the signals in the channels; and
providing dynamic frequency selection information to a plurality of transmitters in a wireless network.

16. The method of claim 15 wherein scanning channels comprises scanning frequency channels below 6 GHz.

17. The method of claim 15 wherein scanning channels comprises scanning frequency channels above 5.25 GHz.

18. The method of claim 15 wherein providing dynamic frequency selection information to a plurality of transmitters comprises transmitting at between 5.15 GHz and 5.25 GHz.

19. The method of claim 15 wherein providing dynamic frequency selection information to a plurality of transmitters comprises transmitting packets to access points across a wired network.

20. The method of claim 15 wherein providing dynamic frequency selection information to a plurality of transmitters comprises identifying a channel to which the wireless network should move.

21. An apparatus including a medium adapted to hold machine-accessible instructions that when accessed result in a machine performing:
scanning channels in a frequency spectrum to detect signals;
storing information describing the signals in the channels; and
providing dynamic frequency selection information to a plurality of transmitters in a wireless network.

22. The apparatus of claim 21 wherein providing dynamic frequency selection information to a plurality of transmitters comprises transmitting at between 5.15 GHz and 5.25 GHz.

23. The apparatus of claim 21 wherein providing dynamic frequency selection information to a plurality of transmitters comprises transmitting packets to access points across a wired network.

24. The apparatus of claim 21 wherein providing dynamic frequency selection information to a plurality of transmitters comprises identifying a channel to which the wireless network should move.

25. An electronic system comprising:
a receiver to detect radar signals in spectrum used by wireless network signals;
a wireless network interface to communicate dynamic frequency selection information to at least one transmitter in a wireless network; and
an omni-directional antenna coupled to the wireless network interface.

26. The electronic system of claim 25 wherein the wireless network interface comprises an 802.11 compliant physical layer.

27. The electronic system of claim 26 wherein the wireless network interface transmits in a radar-free channel.

28. The electronic system of claim 26 wherein the 802.11 compliant physical layer is capable of transmitting at frequencies of between 5.15 GHz and 5.25 GHz.
